(19) United States
(12) Patent Application Publication
(10) Pub. No.: US 2026/0180641 A1
(43) Pub. Date: Jun. 25, 2026

(54) CSI Report Management for Layer 1/Layer 2 Triggered Mobility

(71) Applicant: Apple Inc., CUPERTINO, CA (US)

(72) Inventors: Hong HE, San Jose, CA (US); Ankit BHAMRI, Haar (DE); Chunhai YAO, Beijing (CN); Dawei ZHANG, Saratoga, CA (US); Haitong SUN, Saratoga, CA (US); Huaning NIU, San Jose, CA (US); Wei ZENG, Saratoga, CA (US)

(21) Appl. No.: 18/832,404

(22) PCT Filed: Jul. 25, 2023
(86) PCT No.: PCT/CN2023/109094

§ 371 Date: Jul. 23, 2024

(51) Int. Cl. H04B 7/06; H04B 17/318

(52) U.S. Cl. CPC H04B 7/0626; H04B 17/328

(57) ABSTRACT

A user equipment (UE) is configured to decode, from signaling received from a base station, configuration information for layer 1 (L1)/layer 2 (L2) triggered mobility (LTM) comprising a first parameter configured to indicate a number of candidate cells to be included in a channel state information (CSI) report for LTM and a second parameter configured to indicate a number of beams per candidate cell to be included in the CSI report for LTM and configure transceiver circuitry to transmit the CSI report for LTM, comprising at least a first candidate cell, to the base station based on the configuration information.

### TECHNICAL FIELD

The present disclosure generally relates to wireless communication, and in particular, to CSI report management for layer 1/layer 2 triggered mobility.

### BACKGROUND

A user equipment (UE) may connect a network with Layer 1 (L1)/layer 2 (L2) triggered mobility (LTM). LTM generally refers to a mobility procedure that uses a measurement report with measurement information for one or more candidate cells and one or more beams per candidate cell. It has been identified that there is a need for mechanisms that facilitate the implementation of LTM.

### SUMMARY

Some exemplary embodiments are related to an apparatus of a user equipment (UE). The apparatus having processing circuitry configured to decode, from signaling received from a base station, configuration information for layer 1 (L1)/layer 2 (L2) triggered mobility (LTM) comprising a first parameter configured to indicate a number of candidate cells to be included in a channel state information (CSI) report for LTM and a second parameter configured to indicate a number of beams per candidate cell to be included in the CSI report for LTM and configure transceiver circuitry to transmit the CSI report for LTM, comprising at least a first candidate cell, to the base station based on the configuration information.

Other exemplary embodiments are related to a processor configured to decode, from signaling received from a base station, configuration information for layer 1 (L1)/layer 2 (L2) triggered mobility (LTM) comprising a first parameter configured to indicate a number of candidate cells to be included in a channel state information (CSI) report for LTM and a second parameter configured to indicate a number of beams per candidate cell to be included in the CSI report for LTM and configure transceiver circuitry to transmit the CSI report for LTM, comprising at least a first candidate cell, to the base station based on the configuration information.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a signaling diagram layer 1 (L1)/layer 2 (L2) triggered mobility (LTM) according to various exemplary embodiments.

FIG. 5 shows an exemplary deployment scenario according to various exemplary embodiments.

FIG. 6 shows an example for encoding a channel state information (CSI) report instance for LTM according to various exemplary embodiments.

FIG. 7 shows an example for encoding a CSI report instance for LTM according to various exemplary embodiments.

FIG. 8 shows an example of a CSI report with variable payload size for LTM according to various exemplary embodiments.

FIG. 9 shows an example of a CSI report with variable payload size for LTM according to various exemplary embodiments.

### DETAILED DESCRIPTION

The exemplary embodiments may be further understood with reference to the following description and the related appended drawings, wherein like elements are provided with the same reference numerals. The exemplary embodiments relate to layer 1 (L1)/layer 2 (L2) triggered mobility (LTM).

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate electronic component.

Those skilled in the art will understand that LTM may generally refer to a mobility procedure during which the UE collects measurement data associated with one or more candidate cells and UE then sends a lower-layer measurement report to the network. The network may switch the UE to a target cell based on the lower-layer measurement report. However, reference to LTM is merely provided for illustrative purposes. Different entities may refer to a similar concept by a different name (e.g., lower-layer triggered mobility, etc.).

The exemplary embodiments are further described with regard to a fifth generation (5G) New Radio (NR) network that supports LTM. However, reference to a 5G NR network is merely provided for illustrative purposes. The exemplary embodiments may be utilized with any appropriate type of network (e.g., 5G, 5G advanced, 6G, etc.) that supports LTM.

The exemplary embodiments introduce techniques related to various aspects of reporting channel state information (CSI) for LTM. According to some aspects, the exemplary embodiments introduce techniques for selecting the candidate cells and beams that are to be included in a CSI report for LTM. In other aspects, the exemplary embodiments introduce quantization and encoding techniques for candidate cell measurement data provided in the CSI report for LTM. In further aspects, the exemplary embodiments introduce techniques for determining the contents of the CSI report for LTM. In addition, the exemplary embodiments introduce techniques for the allocation of triggering states for candidate cells in LIM. The exemplary techniques introduced herein may be used independently from one another, in conjunction with currently implemented CSI reporting mechanisms, in conjunction with future implementations of CSI reporting mechanisms or independently from other CSI reporting mechanisms.

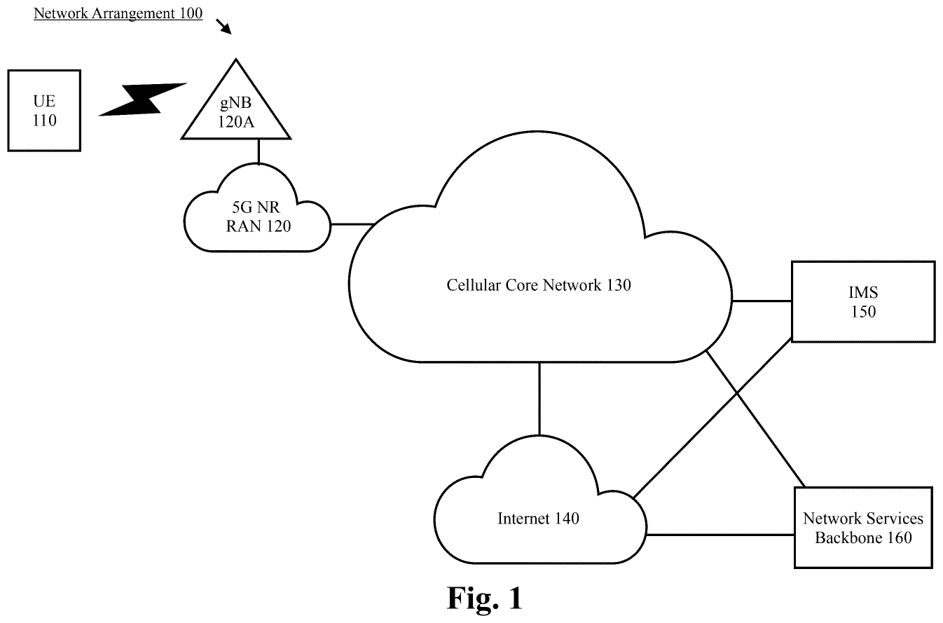

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, it should be understood that the UE 110 may also communicate with other types of networks (e.g., sixth generation (6G) RAN, 5G cloud RAN, a next generate RAN (NG-RAN), a legacy cellular network, a wireless local area network (WLAN), etc.) and the UE 110 may also communicate with networks over a wired connection. Therefore, the UE 110 may have a 5G NR chipset to communicate with the NR RAN 120 and, optionally, any other appropriate type of chipset to communicate with other types of networks.

The 5G NR RAN 120 may be a portion of a cellular network that may be deployed by a network carrier (e. g., Verizon, AT&T, Sprint, T-Mobile, etc.). The 5G NR RAN 120 may include cells and base stations that are configured to send and receive traffic from UEs that are equipped with the appropriate cellular chip set. In this example, the 5G NR RAN 120 includes the gNB 120A. However, reference to a gNB is merely provided for illustrative purposes, the exemplary embodiments may be utilized with any appropriate type of access node (e.g., Node Bs, eNodeBs, HeNBs, eNBs, gNBs, gNodeBs, macrocells, microcells, small cells, femtocells, etc.).

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., the gNB 120A).

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

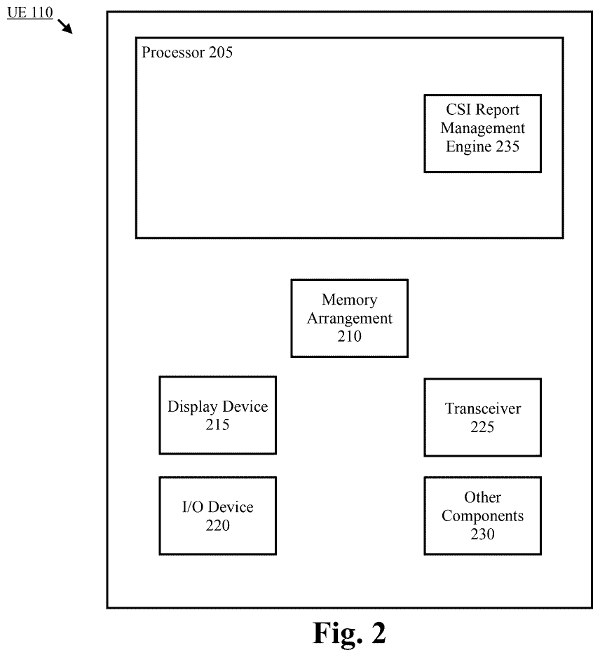

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may, for example, multiple panels each comprising one or more antenna elements, an audio input device, an audio output device, a power supply, a data acquisition device, ports to electrically connect the UE 110 to other electronic devices, etc.

The processor 205 may be configured to execute a plurality of engines of the UE 110. For example, the engines may include a CSI report management engine 235. The CSI report management engine 235 may perform various operations related to measurement reporting for LTM such as, but not limited to, receiving configuration information for LTM, selecting candidate cells and beams that are to be included in the CSI report, encoding measurement data for the CSI report and generating the CSI report for LTM.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

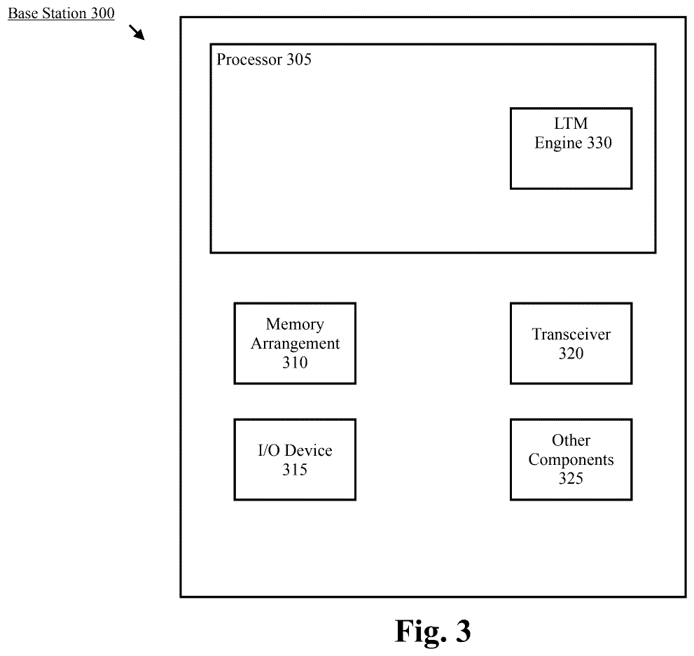

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines of the base station 300. For example, the engines may include an LTM engine 330. The LTM engine 330 may perform various operations related to the configuration and performance of LTM.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.) . The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UE in the network arrangement 100. The transceiver 320 may operate on a variety of different frequencies or channels (e.g., set of consecutive frequencies). The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

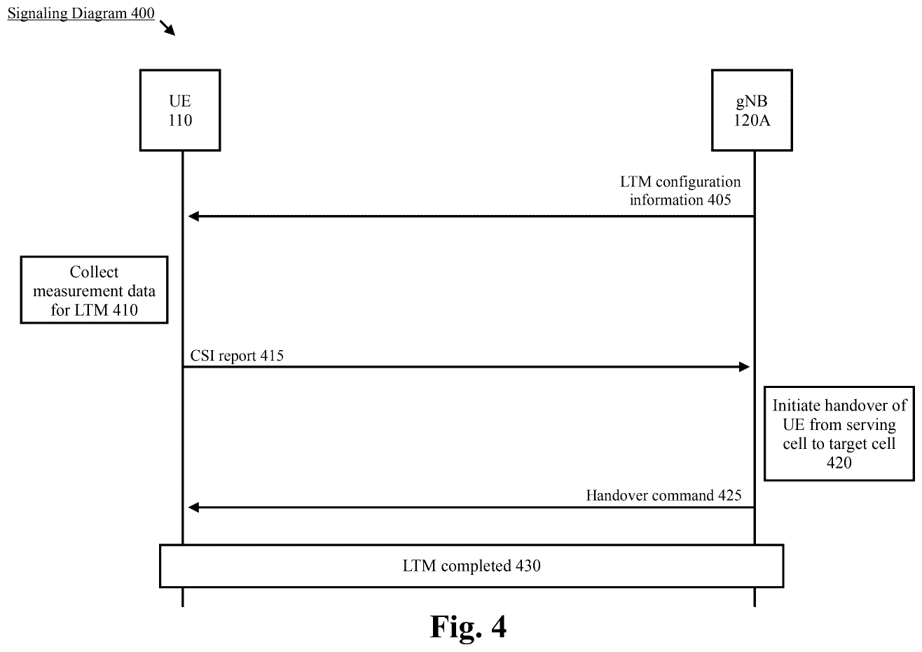

FIG. 4 shows a signaling diagram 400 LTM according to various exemplary embodiments. The signaling diagram 400 is described with regard to the UE 110 and the gNB 120A of FIG. 1. The signaling diagram 400 is provided as a general overview of an example of LTM to provide context for the exemplary embodiments introduced herein. The exemplary embodiments are not limited to the LTM procedure described in the signaling diagram 400 and may be utilized in any appropriate type of mobility procedure.

In 405, the UE 110 receives LTM configuration information from the gNB 120A. The LIM configuration information may be provided to the UE 110 via radio resource control (RRC) signaling or in any other appropriate manner.

The LTM configuration information may include information that facilitates the collection and reporting of measurement data for LTM. To provide some examples, the LTM configuration information may include identification information for candidate cells, trigger conditions for sending a measurement report and/or any other appropriate type of information that may be used for the collection and reporting of measurement data for LTM.

In some of the examples described below, it may be assumed that the network configures the UE 110 to provide a measurement report for LTM that includes measurement data for L candidate cells and M beams per cell where L∈([1], 2,3,4) and M∈(1,2,3,4). Therefore, the LTM configuration information in 405 may include an indication of a number of candidate cells and a number of beams per cell for which the UE 110 is to provide measurement data in a CSI report instance. However, the exemplary embodiments are not limited to L∈([1], 2,3,4) and M∈(1,2,3,4) and may apply to a measurement report configured to include information for any appropriate number of candidate cells and/or beams per cell.

In 410, the UE 110 collects measurement data for LTM. The UE 110 may perform L1-RSRP measurements for one or more candidate cells based on CSI-reference signal (RS), synchronization signal/physical broadcast channel blocks (SSB) and/or any other type of resource. For example, the UE 110 may collect measurement data for a set of candidate cells comprising multiple measured L1-RSRP values for each candidate cell of the set of candidate cells. Each L1-RSRP value may be measured based SSB index for the corresponding candidate cell. However, reference to SSB based L1-RSRP is merely provided for illustrative purposes, the exemplary embodiments may use any appropriate type of measurement data for LTM.

In 415, the UE 110 sends the CSI report to the gNB 120A. The CSI report instance may include measured L1-RSRP values for each candidate cell. Each L1-RSRP value corresponding to an SSB index of a candidate cell. As indicated above, the network may configure the UE 110 to provide measurement data for L candidate cells and M beams per cell. Therefore, the UE 110 may provide M L1-RSRP values for L candidate cells. Further, the UE 110 may be triggered to send the CSI report for LTM based on measurement data corresponding to a candidate cell, measurement data corresponding to a serving cell, a predetermined event and/or any other appropriate type of condition.

In 420, gNB 120A initiates a handover of the UE 110 from a serving cell to a target cell based on the measurement data provided in the CSI report.

In 425, the UE 110 receives a handover command from the gNB 120A. For example, the UE 110 may receive a medium access control (MAC) control element (CE) comprising a cell switch command. However, reference to a MAC CE is merely provided for illustrative purposes. The gNB 120A may provide this type of indication to the UE 110 in any appropriate manner.

In 430, the LTM procedure is completed. In this example, after the UE 110 receives the handover command, the UE 110 may perform a random access procedure towards the target cell and send a message to the gNB 120A indicating successful completion of the LTM procedure. However, the other operations performed during the LTM procedure are beyond the scope of the exemplary embodiments. Instead, the exemplary embodiments introduce mechanisms related to the collection and reporting of measurement data for LTM or any other appropriate type of mobility procedure.

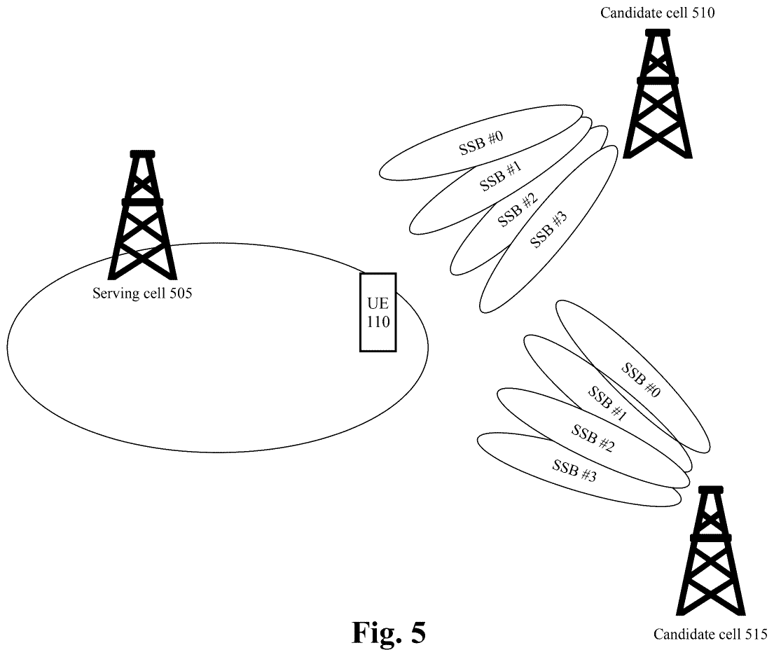

According to some aspects, the exemplary embodiments introduce techniques for selecting which candidate cells and beams are to be included in the CSI report for LTM. To provide an example within the context of the signaling diagram 400, these exemplary techniques may be used by the UE 110 to decide which L candidate cells and M beams per cell are to be included in the CSI report. These exemplary techniques will be described with regard to the exemplary deployment scenario 500 of FIG. 5.

The deployment scenario 500 shows the UE 110, a serving cell 505, a first candidate cell 510 and a second candidate cell 515. In this example, it may be assumed that the candidate cells 510-515 are inter-frequency candidate cells. Candidate cell 510 has 4 beams each corresponding to one SSB from a set of SSBs indexed #0-3 and candidate cell 515 also has 4 beams each corresponding to one SSB from a set of SSBs indexed #0-3.

In one approach, the UE 110 may select the candidate cells and beams based on a highest beam-specific L1-RSRP value. For instance, the UE 110 may perform L1-RSRP measurements on a set of candidate cells. The UE 110 may select L candidate cells from the set of candidate cells with the highest measured ssb-Index-RSRP values. Those skilled in the art will understand that the UE 110 may be configured with a report quantity of ssb-Index-RSRP for L1-RSRP measurements. L1 measurements may be beam specific and thus, each L1-RSRP may correspond to a specific SSB index. For each selected candidate cell, the UE 110 may select M measurements with the highest ss-Index-RSRP values. The UE 110 may include measurement data for the selected candidate cells and SSBs in the CSI report for LTM.

To provide an example of using the above approach within the context of the deployment scenario 500, assume L=1 and M=2. Since L=1, the UE 110 is to include measurement data from only one of the candidate cells in the CSI report.

The UE 110 may perform measurements on candidate cell 510 and collect L1-RSRP for each of the beams indexed #0-3. The UE 110 may also perform measurements on candidate cell 515 and collect L1-RSRP for each of the beams indexed #0-3. In this example, assume beam #1 of candidate cell 510 has the highest measured L1-RSRP value amongst beams #0-3 of candidate cell 510 and beams #0-3 of candidate cell 515. Since candidate cell 510 has the beam with the highest measured L1-RSRP value, candidate cell 510 is selected for the CSI report. It may also be assumed that beams #0 and #1 of candidate cell 510 have higher measured L1-RSRP values than beams #2 and #3 of candidate cell 510. Therefore, the beams #0 and #1 are selected for the CSI report.

In another approach, the UE 110 may select the candidate cells based on an average of the top M L1-RSRP values. For instance, the UE 110 may perform L1-RSRP measurements on candidate cells. For each measured candidate cell i, the UE 110 may derive a measurement quantity Aᵢ based on SSB as the linear power scale average of the M highest beam measurement quantity values. The candidate cells may then be sorted in decreasing order of measurement quantity Aᵢ and the UE 110 may select the L candidate cells that have the highest averaging quantity Aᵢ. For each selected candidate cell, the UE 110 may select the M highest ssb-index-RSRP values. The UE 110 may include measurement data for the selected candidate cells and beams in the CSI report for LTM.

To provide an example of using the above approach within the context of the deployment scenario 500, assume L=1 and M=2. Since L=1, the UE 110 is to include measurement data from only one of the candidate cells in the CSI report.

The UE 110 may perform measurements on candidate cell 510 and collect L1-RSRP for each of the beams indexed #0-3. The UE 110 may also perform measurements on candidate cell 515 and collect L1-RSRP for each of the beams indexed #0-3. In this example, since M=2, the UE 110 averages the 2 highest measured L1-RSRP values to calculate Aᵢ for each candidate cell. It may be assumed that Aᵢ for candidate cell 515 is higher than Aᵢ for candidate cell 510. Therefore, the UE 110 selects candidate cell 515 for the CSI report. The UE 110 may then select the M beams of candidate cell 515 with the highest measured L1-RSRP values. It may also be assumed that beams #1 and #2 of candidate cell 515 have higher measured L1-RSRP values than beams #0 and #3 of candidate cell 515. Therefore, the beams #1 and #2 are selected for the CSI report.

In some embodiments, both of the approaches described above may be supported and configured on a per UE or per CSI report basis. In one example, an RRC parameter is introduced to indicate whether the UE is to select candidate cells and beams for the CSI report based on the highest beam-specific L1-RSRP values or an average of L1-RSRP values. In another example, for an aperiodic CSI report, a 1-bit field is introduced to indicate whether the UE is to select candidate cells and beams for the CSI report based on the highest beam-specific L1-RSRP values or an average of L1-RSRP values.

According to some aspects, the exemplary embodiments introduce quantization and encoding techniques for candidate cell L1-RSRP. The exemplary techniques described below may be used to determine the bit width of measured L1-RSRP values of different SSBs and encoding schemes when more than one candidate cells are reported in a single CSI report instance.

In one approach, the UE 110 may use differential L1-RRP based reporting for the reported L1-RSRP values except for the largest RSRP value amongst the candidate cells. In some examples, the largest measured value of L1-RSRP may be quantized to a 7-bit value with a 1 decibel per milliwatt (dBm) step size in the range of [−140, −44] dBm and the differential L1-RSRP may be quantized to a 4-bit value with a 2 dB step size with a reference to the largest measured L1-RSRP value. The exemplary embodiments are not limited to the example provided above and this approach may be used with any appropriate bit widths.

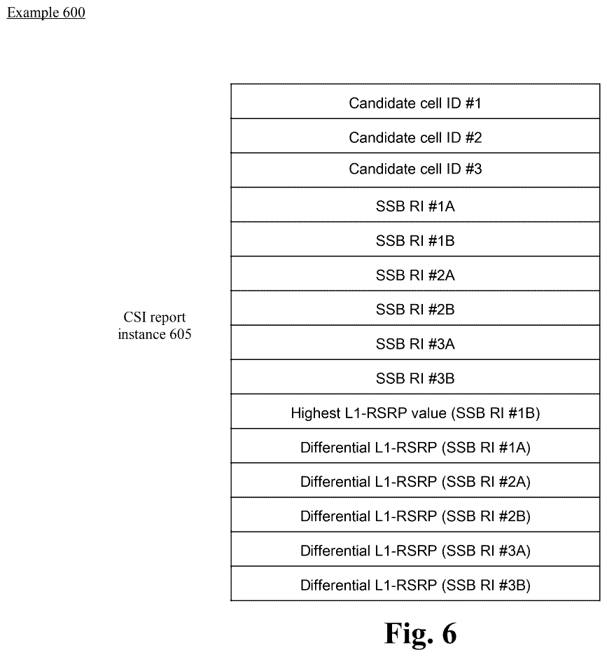

FIG. 6 shows an example 600 for encoding a CSI report instance 605 for LTM according to various exemplary embodiments. The example 600 will be used to illustrate how the exemplary approach described above may be used to generate an CSI report for LTM.

In the example 600, the CSI report instance 605 comprises IDs for multiple candidate cells, e.g., candidate cell ID #1, candidate cell ID #2 and candidate cell ID #3. However, the example of a 3 candidate cell IDs is merely provided for illustrative purposes, the exemplary embodiments may apply to a CSI report for any appropriate number of candidate cells.

The CSI report instance 605 also includes SSB resource indicators (RI) for multiple beams of each candidate cell included in the CSI report. In this example, for each candidate cell, 2 beams are to be reported and thus, there are 2 SSB RIS for each candidate cell. SSB RI #1A and SSB RI #1B correspond to candidate cell ID #1, SSB RI #2A and SSB RI #2B correspond to candidate cell ID #2 and SSB RI #3A and SSB RI 31B correspond to candidate cell ID #3. However, the example of 2 SSB RIS is merely provided for illustrative purposes, the exemplary embodiments may apply to a CSI report for any appropriate number of beams per candidate cell.

In addition, the CSI report instance 605 includes multiple L1-RSRP values each corresponding to a different beam. The highest RSRP value measured by the UE 110 among the beams of candidate cell ID #1, candidate cell ID #2 and candidate cell ID #3 is quantized to a 7-bit value in the range of [−140, −44] dBm with a step value of 1 dBm. For example, it may be assumed that the L1-RSRP for SSB RI #1B of candidate cell ID #1 may be the highest L1-RSRP and thus, this L1-RSRP value is reported as a 7-bit value. The L1-RSRP values for the other beams may be reported as differential L1-RSRP quantized to a 4-bit value with a 2 dBm step size.

In another approach, the UE 110 may use differential L1-RSRP based reporting for the reported L1-RSRP values except for the largest RSRP of each candidate cell. The differential L1-RSRP of a candidate cell may be quantized to a 4-bit value with a 2 dB step seize with a reference to the largest measured L1-RSRP value of the same candidate cell. The exemplary embodiments are not limited to the example provided above and this approach may be used with any appropriate bit widths.

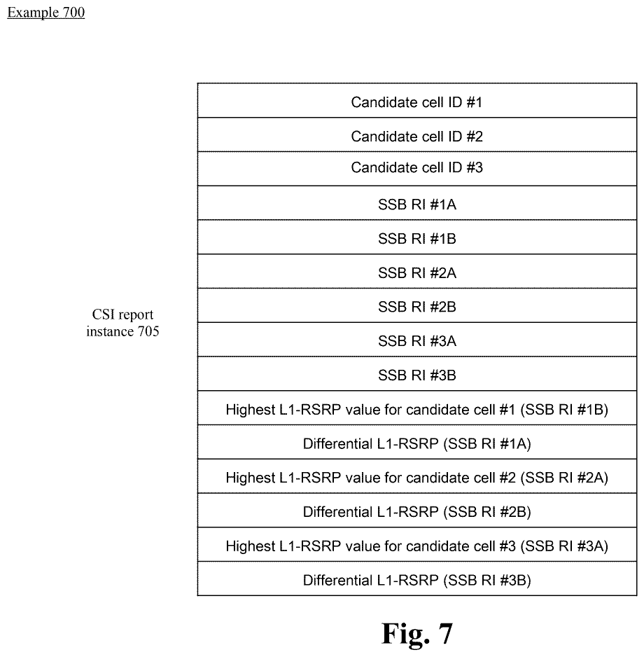

FIG. 7 shows an example 700 for encoding a CSI report instance 705 for LTM according to various exemplary embodiments. The example 700 will be used to illustrate how the exemplary approach described above may be used to generate an CSI report for LTM.

In the example 700, the CSI report instance 705 comprises IDs for multiple candidate cells, e.g., candidate cell ID #1, candidate cell ID #2 and candidate cell ID #3. However, the example of a 3 candidate cell IDs is merely provided for illustrative purposes, the exemplary embodiments may apply to a CSI report for any appropriate number of candidate cells.

The CSI report instance 705 also includes SSB RIs for each candidate cell included in the CSI report. In this example, for each candidate cell, 2 beams are to be reported and thus, there are 2 SSB RIs for each candidate cell. SSB RI #1A and SSB RI #1B correspond to candidate cell ID #1, SSB RI #2A and SSB RI #2B correspond to candidate cell ID #2 and SSB RI #3A and SSB RI 31B correspond to candidate cell ID #3. However, the example of 2 SSB RIs is merely provided for illustrative purposes, the exemplary embodiments may apply to a CSI report for any appropriate number of beams per candidate cell.

In addition, the CSI report instance 705 includes multiple L1-RSRP values each corresponding to a different SSB index. The highest L1-RSRP value measured by the UE 110 for candidate cell ID #1 is reported as a 7-bit value in the range of [−140, −44] dBm with a step value of 1 dBm. For example, it may be assumed that the L1-RSRP for SSB RI #1B of candidate cell ID #1 may be the highest L1-RSRP and thus, this L1-RSRP value is reported as a 7-bit value. The L1-RSRP for the other SSB RI of the candidate cell is reported as differential L1-RSRP using a 4-bit value. For example, the L1-RSRP for SSB RI #1A of candidate cell ID #1 may be reported as a differential L1-RSRP relative to the L1-RSRP for SSB RI #1B using a 4-bit value.

The highest L1-RSRP value measured by the UE 110 for candidate cell ID #2 is reported as a 7-bit value in the range of [−140, −44] dBm with a step value of 1 dBm. For example, it may be assumed that the L1-RSRP for SSB RI #2A of candidate cell ID #2 may be the highest L1-RSRP and thus, this L1-RSRP value is reported as a 7-bit value. The L1-RSRP for the other SSB RI of the candidate cell is reported as differential L1-RSRP using a 4-bit value. For example, the L1-RSRP for SSB RI #2B of candidate cell ID #2 may be reported as a differential L1-RSRP relative to the L1-RSRP for SSB RI #2A using a 4-bit value.

The highest L1-RSRP value measured by the UE 110 for candidate cell ID #3 is reported as a 7-bit value in the range of [−140, −44] dBm with a step value of 1 dBm. For example, it may be assumed that the L1-RSRP for SSB RI #3A of candidate cell ID #3 may be the highest L1-RSRP and thus, this L1-RSRP value is reported as a 7-bit value. The L1-RSRP for the other SSB RI of the candidate cell is reported as differential L1-RSRP using a 4-bit value. For example, the L1-RSRP for SSB RI #3B of candidate cell ID #3 may be reported as a differential L1-RSRP relative to the L1-RSRP for SSB RI #3A using a 4-bit value.

According to some aspects, the exemplary embodiments introduce techniques for determining the content of a CSI report instance based on measured RSRP values of candidate cells. In one approach, the UE 110 may always report CSI for L candidate cells and M beams of each selected candidate cell. As mentioned above, the parameters L and M may be configured by RRC signaling. With this approach, the CSI payload size is fixed.

In another approach, a threshold RRC parameter (absThresh) may be used to manage the content of the CSI report. For example, the network may provide the threshold RRC parameter to the UE 110 in a CSI report IE or in any other appropriate manner. If the absThresh parameter is provided, the measured values with a quantity above the absThresh value are to be included in the CSI report. This approach may be used to minimize the CSI report overhead by only including qualified results. However, using this approach means that the size of the CSI report is not fixed and may vary depending on the number of measured values that exceed the absThresh value. As will be described in more detail below, the exemplary embodiments introduce techniques for handling a variable size CSI report for LTM.

For the variable size CSI report, in one option, the LTM CSI report may be divided into two parts, e.g., LTM CSI part #1 and LTM CSI part #2. LTM CSI part #1 may indicate the total number of reported candidate cells C in a report for all candidate cells. The bit width of this field may be foxed and represented by K₁=[log₂(L)]. LTM CSI Part #2 may include information for each reported candidate cell where the actual number of reported SSB indices is fixed to be M. However, LTM CSI part #2 has a variable payload size and if a L1-RSRP for a beam does not exceed the threshold value, a measurement may not be reported.

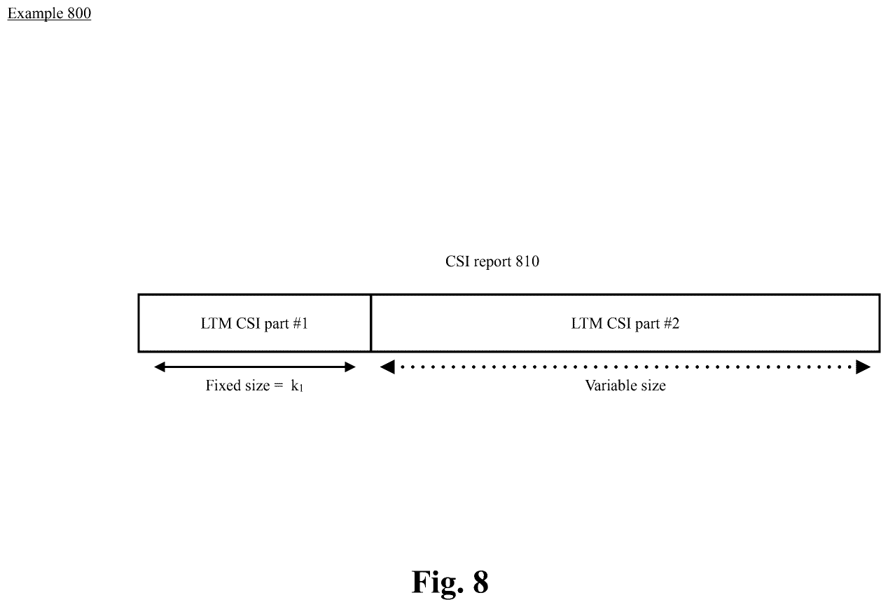

FIG. 8 shows an example 800 of a CSI report 810 with variable payload size for LTM according to various exemplary embodiments. The example 800 illustrates a CSI report 810 that has multiple parts (LTM CSI part #1, LTM CSI part #2) and supports a variable payload size based on comparing the measured RSRP to a configured threshold value (e.g., absThresh). In this example, it may be assumed that L=2 and thus, the bit width for LTM CSI part #1 may be represented by K₁=[log₂(2)]. The size of LTM CSI part #2 may vary depending on the number of beams for each candidate cell that are greater than the threshold value absThresh.

In another option, the exemplary embodiments may use a cyclic repetition-based approach for the variable size CSI report. With this approach, for each candidate cell, the UE 110 determines the measured results whose sorting quantity is above the absThresh value. The UE 110 may then select M beams for the CSI report with a value that is greater than absThresh value.

However, if less there are less than M beams with L1-RSRP above the threshold value, the selected L1-RSRP values may be repeated until the total number of L1-RSRP values for the candidate cell is M. In a scenario where none of the measured results exceed the absThresh value for a selected candidate cell, the highest one or more L1-RSRP values amongst the beams of the candidate cell is selected and may be repeated until the total number of TSRTP values for the candidate cell is M.

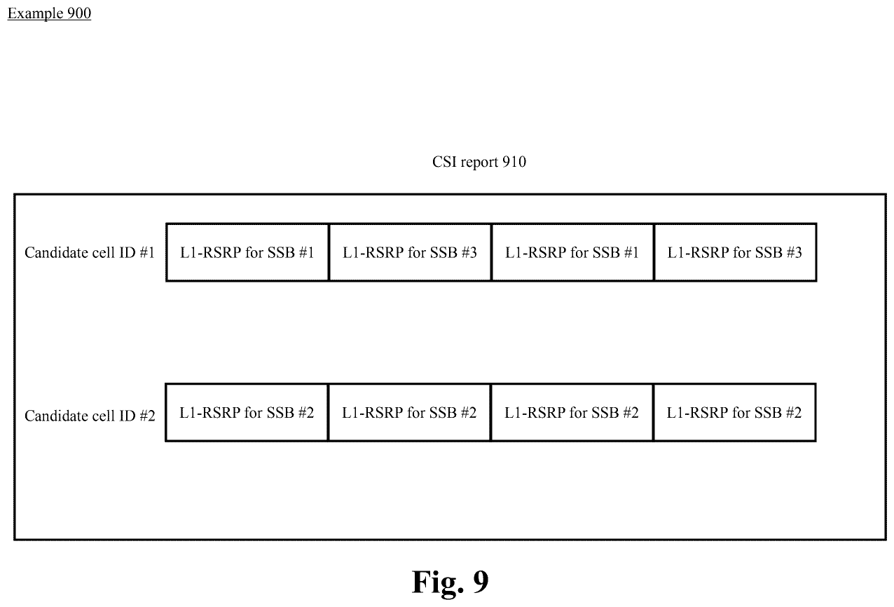

FIG. 9 shows an example 900 of a CSI report 910 with variable payload size for LTM according to various exemplary embodiments. The example 900 illustrates a CSI report 910 that is based on the cyclic repetition-based approach described above. In this example, it may be assumed that L=2 and M=4. Since L=2, 2 candidate cells are selected (candidate cell ID #1 and candidate cell ID #2). For candidate cell ID #1, it may be assumed that only L1-RSRP for SSB #1 and L1-RSRP for SSB #3 are above the absThresh value. Since M=4, the CSI report 910 may include up to 4 L1-RSRP measurements for candidate cell #1 and thus, L1-RSRP for SSB #1 and L1-RSRP for SSB #3 are repeated in the CSI report 910.

For candidate cell ID #2, it may be assumed that only L1-RSRP for SSB #2 is above the absThresh value. Since M=4, the CSI report 910 may include up to 4 L1-RSRP measurements for candidate cell #2 and thus, L1-RSRP for SSB #2 is repeated 3 times to create 4 RSRP reports for candidate cell #2.

According to some aspects, the exemplary embodiments introduce techniques for the allocation of triggering states for candidate cells in LTM. The exemplary embodiments described below may be used for determining the cell that is associated with a trigger state indicated by DCI. In the exemplary described below the indication in the CSI provides the indication via a CSI request field. However, the exemplary embodiments are not limited to using a CSI request field and the indication may be provided to the UE 110 in any appropriate manner.

In one approach, the trigger states for the RRC parameter AperiodicTriggerStateList may be split into two groups. One group may be used to trigger aperiodic CSI reports for the serving cell and the other group may be used to trigger aperiodic CSI reports for candidate cells. In some embodiments, the starting triggering state T₁ may be explicitly indicated by RRC signaling. The triggering state i,i<T₁ may be used for serving cells and the triggering state k,k≥T₁ may be reserved for candidate cells in LTM.

In another approach, a 1-bit CSI request field may be included in the DCI where a first value (e.g., 0) is configured to indicate the triggered CSI report for the serving cell and a second value (e.g., 1) is configured to indicate the triggered CSI report for the candidate cell.

In another approach, control resource sets (CORSETs) may be divided into two groups, e.g., CORESET group #1 and CORESET group #2. When a DCI is detected in CORSET group #1, this may trigger a CSI report for a serving cell. When a DCI is detected in CORESET group #2, this may trigger a CSI report for candidate cells in LTM.

In a further approach, a CSI report may be triggered based on the scrambling sequence [w₀, w₁, . . . , w₂₃] used to scramble the CRC bits of the scheduling DCI. A first scrambling sequence may be used to trigger a CSI report for the serving cell and a second scrambling sequence may be used to trigger a CSI report for candidate cells in LTM.

### EXAMPLES

In a first example, a method is performed by a user equipment (UE), the method comprising decoding, from signaling received from a base station, configuration information for layer 1 (L1)/layer 2 (L2) triggered mobility (LTM) comprising a first parameter configured to indicate a number of candidate cells to be included in a channel state information (CSI) report for LTM and a second parameter configured to indicate a number of beams per candidate cell to be included in the CSI report for LTM an configuring transceiver circuitry to transmit the CSI report for LTM, comprising at least a first candidate cell, to the base station based on the configuration information.

In a second example, the method of the first example, further comprising collecting measurement data for a set of candidate cells, the measurement data comprising multiple measured L1-referecne signal receive power (RSRP) values for each candidate cell of the set of candidate cells and selecting the first candidate cell for the CSI report from the set of candidate cells based on the first candidate cell being associated with a highest measured L1-RSRP value relative to all of the measured L1-RSRP values of the collected measurement data.

In a third example, the method of the second example, further comprising selecting a first beam to be included with the first candidate cell in the CSI report based on the first beam being associated with a highest measured L1-RSRP value measured based on a synchronization signal block (SSB) index.

In a fourth example, the method of the first example, further comprising collecting measurement data for a set of candidate cells, the measurement data comprising multiple measured L1-referecne signal receive power (RSRP) values for each candidate cell of the set of candidate cells, determining a third parameter for each candidate cell from the set of candidate cells, the third parameter indicating an average L1-RSRP value that is derived based on multiple measuredL1-RSRP values corresponding to a same candidate cell and selecting the first candidate cell for the CSI report from the set of candidate cells based on the third parameter for the first candidate cell having a highest value relative to a set of third parameters comprising the third parameter for each candidate cell.

In a fifth example, the method of the fourth example, further comprising selecting a first beam to be included with the first candidate cell in the CSI report based on the first beam being associated with a highest measured L1-RSRP value measured based on a synchronization signal block (SSB) index.

In a sixth example, the method of the first example, further comprising collecting measurement data for a set of candidate cells, the measurement data comprising multiple measured L1-referecne signal receive power (RSRP) values for each candidate cell of the set of candidate cells decode, from signaling received from the base station, a radio resource control (RRC) parameter indicating whether a candidate cell is to be selected for the CSI report for LTM using one of a first mechanism and a second mechanism, wherein the first mechanism is based on a highest measured L1-RSRP value relative to all of the measured L1-RSRP values of the collected measurement data and the second mechanism is based on an average of measured L1-RSRP values for each candidate cell measured based on a synchronization signal block (SSB) index and selecting the first candidate cell for the CSI report from the set of candidate cells based on the measured L1-RSRP measurement data using the indicated one of the first mechanisms and the second mechanism.

In a seventh example, the method of the first example, wherein the CSI report for LTM is an aperiodic CSI report, the method further comprising collecting measurement data for a set of candidate cells, the measurement data comprising multiple measured L1-referecne signal receive power (RSRP) values for each candidate cell of the set of candidate cells, decoding, from signaling received from the base station, a 1-bit indication associated with the aperiodic CSI report indicating whether a candidate cell is to be selected for the CSI report for LTM using one of a first mechanism and a second mechanism, wherein the first mechanism is based on a highest measured L1-RSRP value relative to all of the measured L1-RSRP values of the collected measurement data and the second mechanism is based on an average of measured L1-RSRP values for each candidate cell measured based on a synchronization signal block (SSB) index and selecting the first candidate cell for the CSI report from the set of candidate cells based on the measured L1-RSRP measurement data using the indicated one of the first mechanisms and the second mechanism.

In an eighth example, the method of the first example, further comprising collecting measurement data for a set of candidate cells, the measurement data comprising multiple measured L1-referecne signal receive power (RSRP) values for each candidate cell of the set of candidate cells, wherein each L1-RSRP value is measured based on a synchronization signal block (SSB) index for each candidate cell and selecting one or more candidate cells and multiple beam SSB indexes corresponding to multiple beams to be included in the CSI report for LTM based on the measurement data, wherein the CSI report includes differential L1-RSRP values for multiple SSB indexes that are included in the CSI report except for a single SSB index associated with a highest measured L1-RSRP value.

In a ninth example, the method of the eighth example, wherein the highest measured L1-RSRP value associated with the single SSB index of a selected candidate cell is quantized to a 7-bit value and the other measured L1-RSRP values included in the CSI report for LTM are each quantized to a 4-bit value.

In a tenth example, the method of the first example, further comprising collecting measurement data for a set of candidate cells, the measurement data comprising multiple measured L1-referecne signal receive power (RSRP) values for each candidate cell of the set of candidate cells, wherein each L1-RSRP value is measured based on a synchronization signal block (SSB) index for each candidate cell and selecting one or more candidate cells and multiple SSB indexes corresponding to multiple beams to be included in the CSI report for LTM based on the measurement data, wherein the CSI report includes differential L1-RSRP values for multiple SSB indexes that are included in the CSI report except for the highest measured L1-RSRP value of each candidate cell.

In an eleventh example, the method of the tenth example, wherein the highest measured L1-RSRP value associated with a SSB index for each selected candidate cell is quantized to a 7-bit value and the other measured L1-RSRP values associated with other SSB indexes of the candidate cell or other candidate cells in the CSI report for LTM are each quantized to a 4-bit value.

In a twelfth example, the method of the first example, wherein the first parameter and the second parameter are configured via radio resource control (RRC) signaling and the UE is configured for each CSI report to include measured L1-reference signal receive power (RSRP) values associated with a number of candidate cells equal to the first parameter and a number of synchronization signal blocks (SSB) indexes per candidate cell equal to the second parameter.

In a thirteenth example, the method of the first example, further comprising decoding, from signaling received from the base station, a radio resource control (RRC) parameter comprising a threshold parameter and determining whether a candidate cell is to be included in the CSI report for LTM based on the threshold parameter.

In a fourteenth example, the method of the thirteenth example, wherein the CSI report comprises a first part and a second part, the first part comprising an indication of a total number of candidate cells included in the CSI report and the second part comprising L1-referecne signal receive power (RSRP) values measured based on synchronization signal block (SSB) indexed for one or more candidate cells that are greater than the threshold parameter.

In a fifteenth example, the method of the thirteenth example, further comprising selecting one or more L1-referecne signal receive power (RSRP) values measured based on synchronization signal block (SSB) indexes corresponding to the first candidate cell for the CSI report that are greater than the threshold parameter, wherein L1-RSRP values for the first candidate cell that are less than the threshold parameter are omitted from the CSI report, wherein the one or more L1-RSRP values of the first candidate cell are repeated in the CSI report until a total number of L1-RSRP values included in the CSI report for the first candidate cell are equal to the second parameter.

In a sixteenth example, the method of the first example, further comprising decoding, from signaling received from the base station, radio resource control (RRC) signaling comprising a first group of CSI report trigger states configured to trigger aperiodic CSI for a serving cell and a second group of trigger states configured to trigger aperiodic CSI for a candidate cell and decoding, from signaling received from the base station, downlink control information (DCI) comprising a CSI report trigger state for a cell and determining whether the CSI report trigger state is for the serving cell or the candidate cell based on the RRC signaling.

In a seventeenth example, the method of the first example, further comprising decoding, from signaling received from the base station, downlink control information (DCI) comprising a 1-bit field configured to indicate whether the CSI report is for a serving cell or a candidate cell.

In an eighteenth example, the method of the first example, further comprising decoding, from signaling received from the base station, downlink control information (DCI) configured to trigger the CSI report, wherein a first control resource set (CORESET) is configured to trigger a CSI report for a serving cell and a second different CORESET is configured to trigger a CSI repot for a candidate cell.

In a nineteenth example, the method of the first example, further comprising decoding, from signaling received from the base station, downlink control information (DCI) configured to trigger the CSI report, wherein a first scrambling sequence for the DCI is configured to trigger a CSI report for a serving cell and a second different scrambling sequence for the DCI is configured to trigger a CSI repot for a candidate cell.

In a twentieth example, a processor configured to perform any of the methods of the first through nineteenth examples.

In a twenty first example, a user equipment (UE) comprising a transceiver configured to communicate with a base station and a processor communicatively coupled to the transceiver and configured to perform any of the methods of the first through nineteenth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments described above may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a user equipment (UE), the apparatus comprising processing circuitry configured to:
decode, from signaling received from a base station, configuration information for layer 1 (L1)/layer 2 (L2) triggered mobility (LTM) comprising a first parameter configured to indicate a number of candidate cells to be included in a channel state information (CSI) report for LTM and a second parameter configured to indicate a number of beams per candidate cell to be included in the CSI report for LTM; and
configure transceiver circuitry to transmit the CSI report for LTM, comprising at least a first candidate cell, to the base station based on the configuration information.

2. The apparatus of claim 1, wherein the processing circuitry is further configured to:
collect measurement data for a set of candidate cells, the measurement data comprising multiple measured L1-referecne signal receive power (RSRP) values for each candidate cell of the set of candidate cells; and
select the first candidate cell for the CSI report from the set of candidate cells based on the first candidate cell being associated with a highest measured L1-RSRP value relative to all of the measured L1-RSRP values of the collected measurement data.

3. The apparatus of claim 2, wherein the processing circuitry is further configured to:
select a first beam to be included with the first candidate cell in the CSI report based on the first beam being associated with a highest measured L1-RSRP value measured based on a synchronization signal block (SSB) index.

4. The apparatus of claim 1, wherein the processing circuitry is further configured to:
collect measurement data for a set of candidate cells, the measurement data comprising multiple measured L1-referecne signal receive power (RSRP) values for each candidate cell of the set of candidate cells;
determine a third parameter for each candidate cell from the set of candidate cells, the third parameter indicating an average L1-RSRP value that is derived based on multiple measuredL1-RSRP values corresponding to a same candidate cell; and
select the first candidate cell for the CSI report from the set of candidate cells based on the third parameter for the first candidate cell having a highest value relative to a set of third parameters comprising the third parameter for each candidate cell.

5. The apparatus of claim 4, wherein the processing circuitry is further configured to:
select a first beam to be included with the first candidate cell in the CSI report based on the first beam being associated with a highest measured L1-RSRP value measured based on a synchronization signal block (SSB) index.

6. The apparatus of claim 1, wherein the processing circuitry is further configured to:
collect measurement data for a set of candidate cells, the measurement data comprising multiple measured L1-referecne signal receive power (RSRP) values for each candidate cell of the set of candidate cells decode, from signaling received from the base station, a radio resource control (RRC) parameter indicating whether a candidate cell is to be selected for the CSI report for LTM using one of a first mechanism and a second mechanism, wherein the first mechanism is based on a highest measured L1-RSRP value relative to all of the measured L1-RSRP values of the collected measurement data and the second mechanism is based on an average of measured L1-RSRP values for each candidate cell measured based on a synchronization signal block (SSB) index; and
select the first candidate cell for the CSI report from the set of candidate cells based on the measured L1-RSRP measurement data using the indicated one of the first mechanisms and the second mechanism.

7. The apparatus of claim 1, wherein the CSI report for LTM is an aperiodic CSI report, wherein the processing circuitry is further configured to:
collect measurement data for a set of candidate cells, the measurement data comprising multiple measured L1-referecne signal receive power (RSRP) values for each candidate cell of the set of candidate cells;
decode, from signaling received from the base station, a 1-bit indication associated with the aperiodic CSI report indicating whether a candidate cell is to be selected for the CSI report for LTM using one of a first mechanism and a second mechanism, wherein the first mechanism is based on a highest measured L1-RSRP value relative to all of the measured L1-RSRP values of the collected measurement data and the second mechanism is based on an average of measured L1-RSRP values for each candidate cell measured based on a synchronization signal block (SSB) index; and
select the first candidate cell for the CSI report from the set of candidate cells based on the measured L1-RSRP measurement data using the indicated one of the first mechanisms and the second mechanism.

8. The apparatus of claim 1, wherein the processing circuitry is further configured to:
collect measurement data for a set of candidate cells, the measurement data comprising multiple measured L1-referecne signal receive power (RSRP) values for each candidate cell of the set of candidate cells, wherein each L1-RSRP value is measured based on a synchronization signal block (SSB) index for each candidate cell; and
select one or more candidate cells and multiple beam SSB indexes corresponding to multiple beams to be included in the CSI report for LTM based on the measurement data, wherein the CSI report includes differential L1-RSRP values for multiple SSB indexes that are included in the CSI report except for a single SSB index associated with a highest measured L1-RSRP value.

9. The apparatus of claim 8, wherein the highest measured L1-RSRP value associated with the single SSB index of a selected candidate cell is quantized to a 7-bit value and the other measured L1-RSRP values included in the CSI report for LTM are each quantized to a 4-bit value.

10. The apparatus of claim 1, wherein the processing circuitry is further configured to:
collect measurement data for a set of candidate cells, the measurement data comprising multiple measured L1-referecne signal receive power (RSRP) values for each candidate cell of the set of candidate cells, wherein each L1-RSRP value is measured based on a synchronization signal block (SSB) index for each candidate cell; and
select one or more candidate cells and multiple SSB indexes corresponding to multiple beams to be included in the CSI report for LTM based on the measurement data,
wherein the CSI report includes differential L1-RSRP values for multiple SSB indexes that are included in the CSI report except for the highest measured L1-RSRP value of each candidate cell.

11. The apparatus of claim 10, wherein the highest measured L1-RSRP value associated with a SSB index for each selected candidate cell is quantized to a 7-bit value and the other measured L1-RSRP values associated with other SSB indexes of the candidate cell or other candidate cells in the CSI report for LTM are each quantized to a 4-bit value.

12. The apparatus of claim 1, wherein the first parameter and the second parameter are configured via radio resource control (RRC) signaling and the UE is configured for each CSI report to include measured L1-reference signal receive power (RSRP) values associated with a number of candidate cells equal to the first parameter and a number of synchronization signal blocks (SSB) indexes per candidate cell equal to the second parameter.

13. The apparatus of claim 1, wherein the processing circuitry is further configured to:
decode, from signaling received from the base station, a radio resource control (RRC) parameter comprising a threshold parameter; and
determine whether a candidate cell is to be included in the CSI report for LTM based on the threshold parameter.

14. The apparatus of claim 13, wherein the CSI report comprises a first part and a second part, the first part comprising an indication of a total number of candidate cells included in the CSI report and the second part comprising L1-referecne signal receive power (RSRP) values measured based on synchronization signal block (SSB) indexed for one or more candidate cells that are greater than the threshold parameter.

15. The apparatus of claim 13, wherein the processing circuitry is further configured to:
select one or more L1-referecne signal receive power (RSRP) values measured based on synchronization signal block (SSB) indexes corresponding to the first candidate cell for the CSI report that are greater than the threshold parameter,
wherein L1-RSRP values for the first candidate cell that are less than the threshold parameter are omitted from the CSI report,
wherein the one or more L1-RSRP values of the first candidate cell are repeated in the CSI report until a total number of L1-RSRP values included in the CSI report for the first candidate cell are equal to the second parameter.

16. The apparatus of claim 1, wherein the processing circuitry is further configured to:
decode, from signaling received from the base station, radio resource control (RRC) signaling comprising a first group of CSI report trigger states configured to trigger aperiodic CSI for a serving cell and a second group of trigger states configured to trigger aperiodic CSI for a candidate cell;
decode, from signaling received from the base station, downlink control information (DCI) comprising a CSI report trigger state for a cell; and
determine whether the CSI report trigger state is for the serving cell or the candidate cell based on the RRC signaling.

17. The apparatus of claim 1, wherein the processing circuitry is further configured to:
decode, from signaling received from the base station, downlink control information (DCI) comprising a 1-bit field configured to indicate whether the CSI report is for a serving cell or a candidate cell.

18. The apparatus of claim 1, wherein the processing circuitry is further configured to:
decode, from signaling received from the base station, downlink control information (DCI) configured to trigger the CSI report, wherein a first control resource set (CORESET) is configured to trigger a CSI report for a serving cell and a second different CORESET is configured to trigger a CSI repot for a candidate cell.

19. The apparatus of claim 1, wherein the processing circuitry is further configured to:
decode, from signaling received from the base station, downlink control information (DCI) configured to trigger the CSI report, wherein a first scrambling sequence for the DCI is configured to trigger a CSI report for a serving cell and a second different scrambling sequence for the DCI is configured to trigger a CSI repot for a candidate cell.

20. A processor configured to:
decode, from signaling received from a base station, configuration information for layer 1 (L1)/layer 2 (L2) triggered mobility (LTM) comprising a first parameter configured to indicate a number of candidate cells to be included in a channel state information (CSI) report for LTM and a second parameter configured to indicate a number of beams per candidate cell to be included in the CSI report for LTM; and
configure transceiver circuitry to transmit the CSI report for LTM, comprising at least a first candidate cell, to the base station based on the configuration information.
